(19) United States
(12) Patent Application Publication
(10) Pub. No.: US 2007/0018364 A1
(43) Pub. Date: Jan. 25, 2007

(54) Modification of nonwovens in intelligent nips

(76) Inventor: Pierre Riviere, Bas-Rhin (FR)

Correspondence Address: FROMMER LAWRENCE & HAUG, 745 FIFTH AVENUE- 10TH FL., NEW YORK, NY, 10151, US

(21) Appl. No.: 11/185,386

(22) Filed: Jul. 20, 2005

(51) Int. Cl. B29C 67/20

(52) U.S. Cl. 264/516; 264/175; 264/40.1; 425/327; 425/324.1; 425/140; 425/143; 425/149

(57) ABSTRACT

A method and apparatus for forming a nonwoven product, including steps of forming a nonwoven web from a material and calendering the nonwoven web received following the forming step on a calender means. The method also including a step of obtaining information pertaining to a number of parameters of the calender means or to the formed nonwoven web from a sensor and controlling the calender means with the obtained information.

### FIELD OF THE INVENTION

The present invention is directed towards an apparatus and method for forming a fibrous media. Specifically, the present invention relates to an apparatus and method for manufacturing nonwovens.

### BACKGROUND OF THE INVENTION

The production of nonwoven products is well known in the art. Such products are produced directly from fibers without conventional textile methods such as weaving or knitting operations. Instead, they may be produced by nonwoven manufacturing methods such as airlaid, drylaid, carding, spunlacing or some combination of these processes in which fibers are laid down to form an integral nonwoven web.

Nonwoven product may also be produced by air-laying or carding operations where the web of fibers is consolidated or processed, subsequent to deposition, into a nonwoven product by needling or hydroentanglement. In the latter, high-pressure water jets are directed vertically down onto the web to entangle the fibers with each other. In needling, the entanglement is achieved mechanically through the use of a reciprocating bed of barbed needles which force fibers on the surface of the web further thereinto during the entry stroke of the needles.

There presently exists apparatus for the production of nonwovens, for example, spunbond webs, structures or articles formed from filaments or fibers typically made from a thermoplastic resin. Such an apparatus is disclosed in U.S. Pat. No. 5,814,349 issued Sep. 29, 1998, the disclosure of which is incorporated herein by reference. These typically include a spinneret for producing a curtain of strands and a process-air blower for blowing process air onto the curtain of strands for cooling the same to form thermoplastic filaments. The thermoplastic filaments are then typically, aerodynamically entrained by the process air for aerodynamic stretching of the themoplastic filaments which are then, after passing through a diffuser, deposited upon a continuously circulating sieve belt for collecting the inter-entangled filaments and forming a web thereon. The web, structure or article, so formed, is then transferred and subject to further processing.

In the meltblown process for manufacturing nonwoven materials, thermoplastic forming polymer is placed in an extruder and is then passed through a linear die containing about twenty to forty small orifices per inch of die width. Convergent streams of hot air rapidly attenuate the extruded polymer steams to form solidifying filaments. The solidifying filaments are subsequently blown by high velocity air onto a take-up screen or another layer of woven or nonwoven material thus forming a meltblown web.

The spunbonding and meltblowing process can be combined in applications such as SMS. In SMS a first layer of spunbonded material is formed on a belt or conveyor. The belt typically has a uniform surface and air permeability to attain the right web formation during the spunbond process. The spunbonded material is deposited on the belt at the lay down forming area to form the web in a first spunbond beam. A pressure nip, or a system such as utilizing a hot air knife can help to enhance pre-bonding pressure and/or temperature acting on the web. In order to assist in drawing the thermoplastic fibers onto the forming belt, a vacuum box is located beneath the belt and which applies suction to the belt. The airflow needed for the spunbond process is supplied to the system by a vacuum box connected to the appropriately sized vacuum pump.

Next, in the meltblown beam, short small fibers are blown onto the spunbond web layer. During the meltblowing process there is typically no need for precompaction press rolls. Finally, a second spunbond beam with press rolls applies a second spunbond layer onto the web formed of the meltblown layer and the first spunbond layer. The composite spunbond-meltblown-spunbond material is then consolidated through a calender nip or a dryer mechanism (not shown).

Nonwoven products are used in a wide variety of applications where the engineered qualities of the product can be advantageously employed. These types of products differ from traditional woven or knitted fabrics in that the fibers or filaments of the product are integrated into a coherent web without traditional textile weaving or knitting processes. Entanglement of the fibrous elements of the nonwoven web coupled with other processes such as chemical or thermal bonding provides the desired product integrity, functionality, and aesthetics.

Nonwoven products are generally made up of fibers locked into place by fiber interaction to provide a strong cohesive structure, with or without the need for chemical binders or filament fusing. The products may have a repeating pattern of entangled fiber regions, of higher area density (weight per unit area) than the average area density of the product, and interconnecting fibers which extend between the dense entangled regions and are randomly entangled with each other in the dense entangled regions. Localized entangled regions may be interconnected by fibers extending between adjacent entangled regions to define regions of lower area density than that of the adjacent high-density region. A pattern of apertures substantially free from fibers may be defined within or between the dense entangled regions and interconnecting fibers. In some products the dense entangled regions are arranged in a regular pattern and joined by ordered groups of fibers to provide a nonwoven product having an appearance similar to that of a conventional woven fabric, but in which the fibers proceed randomly through the product from entangled region to entangled region. The fibers of an ordered group may be either substantially parallel or randomly disposed relative to one another. Embodiments include nonwoven products having complex fiber structures with entangled fiber regions interconnected by ordered fiber groups located in different thickness zones of the nonwoven, which are particularly suitable for apparel, including dress goods and suiting materials, and industrial products such as wipes.

As stated, the nonwoven web may be processed and the fibers locked into place in the product by fiber interaction. By “locked into place” is meant that individual fibers of the structure not only have no tendency to move from their respective positions in the patterned structure but are actually physically restrained from such movement by interaction with themselves and/or with other fibers of the product. Fibers are locked into place in the entangled fiber regions of higher area density than the average area density of the product, and such fiber interaction may also occur elsewhere.

By “interaction” it is meant that the fibers turn, wind, twist back-and-forth, and pass about one another in all directions of the structure in such an intricate entanglement that they interlock with one another.

Mechanical entanglement processes such as needling bind or secure a layer or layers of fibers to themselves or also to a substrate by impaling the fibrous webs with a large number of barbed needles in a device called a needle loom or fiber locker. This action pushes fibers from the fiber layer surface into and through the bulk of the web layers. While strength properties are improved by this entangling of fibers within the web, the process can be slow, the needles can damage the fibers and are themselves (needles) worn out rapidly.

In order to avoid these problems hydroentangling (or “spunlacing”) processes have been developed which use the energy of small-diameter, highly coherent jets of high-pressure water to mimic the entangling action of the older needle loom. The method involves forming a fiber web as described above, after which the fibers are entangled by means of very fine water jets under high pressure. Several rows of water jets are directed against the fiber web which is supported by a movable wire or fabric. The entangled fiber web is then dried. The fibers that are used in the material can be synthetic or regenerated staple fibers, e.g. polyester, polyamide, polypropylene, rayon or the like, cellulose or other natural fibers or mixtures of any combination of these materials. Spunlace materials can be produced in high quality to a reasonable cost and have a high absorption capacity. They can be used as wiping material for household or industrial use, as disposable materials in medical care and for hygiene purposes etc.

The hydroentangling process can be used to produce a large number of different products by varying the initial material and/or the belt/patterning member used. The initial material may consist of any web, mat, batt or the like of loose fibers disposed in random relationship with one another or in any degree of alignment. The term “fiber” as employed herein is meant to include all types of fibrous material, whether naturally or synthetically produced, comprises fibrids, paper fibers, textile staple fibers and continuous filaments. Improved properties can be obtained by suitable combinations of short and long fibers. Reinforced products are provided by combinations of staple length fibers with substantially continuous fibrous strands, where the term “strands” includes continuous filaments and various forms of conventional textile fibers, which may be straight or crimped, and other desirable products are obtained by using highly crimped and/or elastic fibers in the initial material. Particularly desirable patterned, nonwoven products are prepared by using an initial material comprising fibers having a latent ability to elongate, crimp, shrink, or otherwise change in length, and subsequently treating the patterned, nonwoven structure to develop the latent properties of the fibers so as to alter the free-length of the fibers. The initial material may contain different types of fibers, e.g., shrinkable and nonshrinkable fibers, to obtain special effects upon activation of the latent properties of one type of fiber.

While each of these methods of formation and processing of nonwovens has its advantages, current manufacturing systems do not provide a system or method capable of obtaining a large range of nonwoven web properties at different production or processing steps. Further, the present systems do not provide a system or method for sensing different operating and physical conditions of the nonwoven during production and processing and providing for the alteration or optimization of those parameters based on the sensed values during the production. The present invention is directed to overcoming this and other shortcomings of the known systems.

### SUMMARY OF THE INVENTION

It is therefore a principal object of the invention to provide a means for modifying the characteristics of a nonwoven web product through the use of a shoe calender.

It is a further object to provide a method and apparatus for utilizing operating characteristics of a nonwoven web production line to alter the characteristics of a nonwoven product formed thereon.

One aspect of the present invention is directed to an apparatus for forming a nonwoven product including formation means for receiving a material and for forming a nonwoven web therefrom and the shoe calender for modifying the formed nonwoven web. The apparatus includes sensing means for sensing information pertaining to a number of parameters of the shoe calender or to the formed nonwoven web, and wherein the shoe calender is operable to be controlled in accordance with the sensed information obtained from said sensing means.

A further aspect of the present invention is a method of forming a nonwoven product. The method includes steps of forming a nonwoven web from a material and calendering the nonwoven web in a shoe calender nip. The method also includes a step of obtaining information pertaining to a number of parameters of the shoe calender nip or to the formed nonwoven web from a sensor, and controlling the shoe calender nip with the information. In addition, before the nonwoven web enters the calender nip, a hot air stream or other heat source can be directed onto or through the fibrous web to heat or “precondition” the fibrous web in order to enhance the effect upon the web as it passes through the shoe calender nip, such effects include, but are not limited to, the densification, reshaping, and shape memorization of the fibers and nonwoven web.

These and other objects and advantages are provided by the present invention. In this regard, the present invention is directed towards a method for modifying the density, structure, and the fibers/filament cohesion of a nonwoven web, by processing it through an intelligent shoe calender nip in which the specific pressure profile, temperature, and/or speed are varied.

### BRIEF DESCRIPTION OF THE DRAWINGS

Thus by the present invention, its objects and advantages will be realized the description of which should be taken in conjunction with the drawings wherein:

FIG. 1 is a side view of a theoretical nonwoven production line depicting various positions for a shoe calender on a nonwoven production line, according to the present invention;

FIG. 2 is a view of an example of a shoe nip profile, incorporating the teachings of the present invention;

FIG. 3 is a view of an example of a shoe nip profile, incorporating the teachings of the present invention;

FIG. 4 is a view of an example of a shoe nip profile, incorporating the teachings of the present invention;

FIG. 5 is a standard shoe calender used in the production of paper and paperboard products; and

FIG. 6 is a profile view of a shoe calender according to one embodiment of the present invention.

### DETAILED DESCRIPTION OF THE PREFERRED EMBODIMENTS

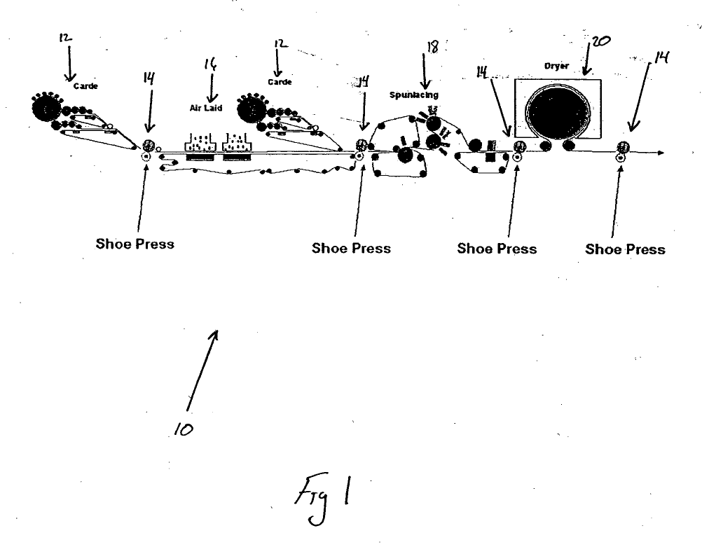

Turning now more particularly to the drawings, FIG. 1 illustrates a number of processing and production steps that may appear in a typical nonwoven production system 10. While shown together, in practice the elements of system 10 may or may not be used in the production of a single nonwoven. As can be seen, the system 10 includes several different processing steps. In addition, FIG. 1 shows various possible positions for a shoe calender 14, in the nonwoven production line or in relation to various production and processing elements in a theoretical nonwoven production line.

For example, the shoe calender 14 can be placed on the nonwoven web manufacturing line just after a formation apparatus 12 or 16 which may include one or more of carding, air laid, spun bond, melt blown, and wet laid processes. Alternatively, the shoe calender 14 may be situated after one of a web-processing step 18 or 20, which may include one of spun lace, dryer, or thermo-bonding processes.

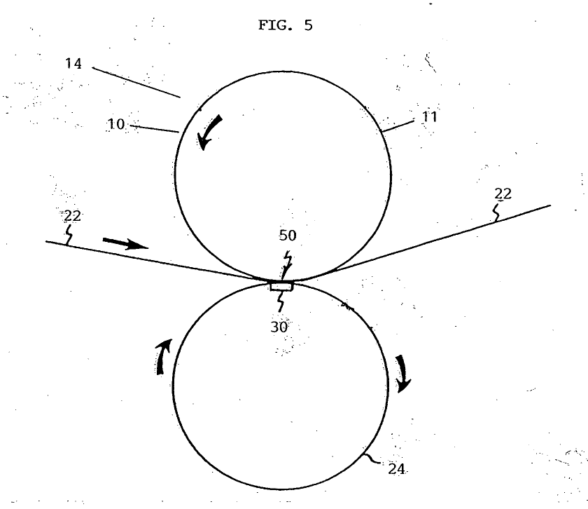

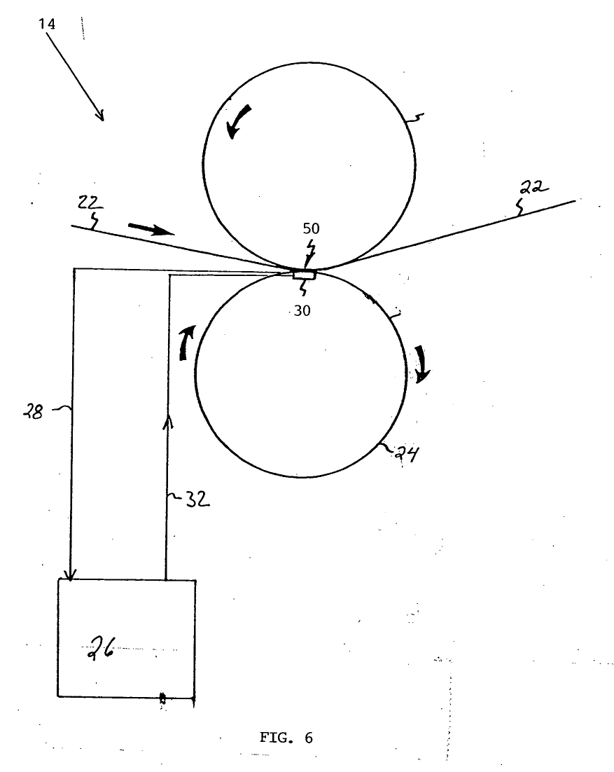

Typically the shoe calender 14 as shown in FIG. 6 may be configured to act as a hot calender, a Sanfor calender or a Fuller calender depending on the system in which it is being used and the characteristics of the nonwoven that are desired. The calender itself is typically a machine having two or more rolls or a roll and a shoe which apply uniform pressure to the fabric as the fabric is passed through the nip. Further discussion and description of a calender shoe press used in paper making can be found in U.S. Pat. No. 5,836,242, which is incorporated herein by reference. Briefly, however, this reference shows a calendering system typically used in papermaking and is illustrated in FIG. 5. In this embodiment, the calender shoe press or calender shoe 14 is defined by a heated roll 11 and an opposed, substantially stationary, press shoe 30 supported by a stationary beam (not shown). A calender belt 24 runs in an endless path around the press shoe 30. A required frictional reduction on belt 24 is brought about in known manner by means of an oil film on the press shoe 20, in which case the belt 24 must be impermeable.

Sanforizing is a common technique used to prevent the shrinking of fabrics. Similarly, Fulling is a process where a combination of heat, pressure and some additive such as water or a lubricant is used to entangle fibers for increased strength. For both of these processes, once set in place for a particular production run, the characteristics of the calender are largely static. That is, they are not easily changed, and in fact are not easily monitored during the production run. It has been found that relying on the machine settings during the production run is not always desirable and the receipt of real time information regarding the production run as well as the ability to alter the forces being imparted on the nonwoven during the production run are both desirable and necessary to eliminate waste and increase the productivity of the production line.

One aspect of the present invention is the use of a shoe calender to improve nonwoven web processing and to provide desirable characteristics and technical specifications to the web. For example, calendering can be used to affect the bulk density of the fabric by changing the thickness. It can also affect the smoothness of the surface, especially if heated. Such a system may also improve the spun lacing/entangling efficiency, or facilitate obtaining a particular web hand. This is accomplished through the use of a shoe calender as described above in combination with, for example, hydroentangling processes 18 and drying process 20 as shown in FIG. 1.

Further, where the desired properties of the nonwoven are known, for example, where the desired property is a repeating high-density web area followed by a repeated low-density web area, where the speed of the production line is known or ascertainable, the graph in FIG. 3 may provide an example of the pressure or temperature curves that the calender will desirably produce. Given this reference point, through the use of a computer or “intelligent” system, the graph can be used as a control curve to alter the settings of the calender so that the desired nonwoven is so produced.

Such a system is shown in FIG. 6 where the nonwoven web 22 is processed through the shoe calender 14. The sensors may be imbedded in one or more of the pressure roll 50, the arcuate shoe 30, or the calender belt 24. The sensors produce a signal which is shown generally by signal line 28. The signal is sent to a computer or data processor 26, that interprets the signal, compares the actual data received with the model, such as that represented by the graph in FIG. 3, and then sends a control signal 32 to the shoe calender 14 which instructs the shoe calender 14 to increase or decrease temperature, pressure, speed, or the like depending on the comparison. This creates a process feedback/control loop which may, if desired, automatically adjust the shoe calender 14 operation to the desired operational parameters.

Of particular note, with regard to the system shown by FIG. 6, is the ability to change the pressure applied by the shoe of the shoe calender to the nonwoven web. In a shoe press, the shoe rests on a piston or beam which can be raised or lowered by use of oil pressure. By increasing or decreasing the amount of oil under the piston, the shoe press is forced closer or allowed to move away from the opposing press roll of the calender. Additionally, the mating roll may also be movable allowing for loading of the nip and increased nip pressure. By altering the pressure at some timed interval, pulses are created, and in the nonwoven web will cause areas of high and low density respectively. In this fashion alterations to the nonwoven's physical properties are possible. Further, such use is in contrast to the normal use of a calender, where the desire is to create a nonwoven having uniform characteristics in both the MD and CD directions. Other variations may be useful in nonwoven production, such as a unique shoe replacement (with respect to the center line of the heating roll), or control or design of the shoe so that the aforesaid pressure pulses can be used to build or refine surface properties (e.g. smoothness) in the nonwoven product. Other ways to vary the pressure of the shoe, its position and modification of its design will, or course, be apparent to one skilled in the art.

The use of sensors allows the system to ascertain the characteristics that are being imparted on the nonwoven product through the calendering process. For example, in one embodiment of the present invention a thermocouple may be imbedded in the surface of the calender roll or shoe for the sensing of temperature, while a transducer such as a pizeo crystal which senses the pressure being imparted on the nonwoven during the calendering process may also or alternatively be included. Similarly, a tachometer may be used to ascertain the speed of the production line and yet other devices may be used to ascertain the stretch imparted to the nonwoven during production and processing.

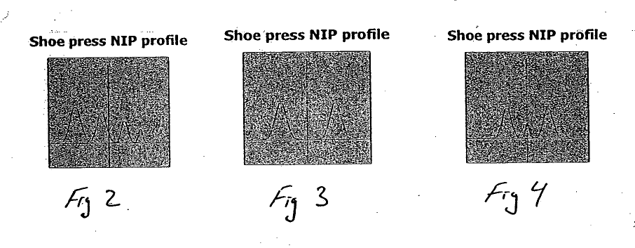

Further, by gathering the information or data as discussed above, it is possible to provide a method and system where the pressure, temperature, or speed is altered during production. Alternatively it can be set to be altered over time in either a repeating or non-repeating pattern in order to produce desired effects in the nonwoven. FIGS. 2-4 depict examples of pressure profiles in a shoe calender nip that may be desirable in a nonwoven production line during the production of nonwovens. By increasing and decreasing the pressure according to the pressure profiles, the density of the fabric across the CD direction of the fabric may be altered. This may be repeatedly altered to create a reoccurring pattern in the MD direction. The density variations on a repeating basis can be used to create desired characteristics including simple aesthetics, a controlled wicking surface or a 3-D geometry.

Speed may also be varied to either stretch or shrink the fabric as desired. This may vary the localized basis weight of the fabric. Uses include, but are not limited to providing a location within the nonwoven where the nonwoven is to be cut or pressed into flat goods from rolled goods.

By this process a single shoe calender is capable of modifying the density, structure, and the fibers/filament cohesion of a nonwoven web, by processing it through one or more “intelligent” shoe nips in which the specific pressure, temperature, and/or speed are varied. As a result the shoe calendar 14 is capable of operating as hot calendar, a Sanfor calendar, or a Fuller calendar.

Thus by the present invention its objects and advantages are realized, and although preferred embodiments have been disclosed and described in detail herein, its scope and objects should not be limited thereby; rather its scope should be determined by that of the appended claims.

What is claimed is:

1. An apparatus for forming a nonwoven product, said apparatus comprising:
formation means for receiving a material and for forming a nonwoven web therefrom;
calender means for receiving the formed nonwoven web; and
acting thereon with said calender means, wherein said calender means comprises a shoe calender.

2. The apparatus of claim 1, further comprising sensing means for sensing information pertaining to one or more parameters of said calender means or from the formed nonwoven web, and wherein said calender means is operable to be controlled in accordance with the sensed information obtained from said sensing means.

3. The apparatus of claim 1, wherein said calender means is located in a formation section or in a web-processing section of said apparatus.

4. The apparatus of claim 1, wherein said formation means is a carding, airlaid, spunbound, melt blown, spunlace, or wet laid operation.

5. The apparatus of claim 3, wherein said web-processing means is a dryer or thermo bonding operation.

6. The apparatus of claim 1, wherein said calender means may be controlled in accordance with the sensed information obtained from said sensing means through a process feedback/control loop.

7. The apparatus of claim 2, wherein said parameters include pressure, temperature, speed of said calender means; or elongation of said formed nonwoven web.

8. The apparatus of claim 2, further comprising control drive means on said apparatus for adjusting operating parameters of said calender means; and a controller means responsive to said sensing means and operably connected to said control drive means.

9. A method of forming a nonwoven product, said method comprising the steps of:
forming a nonwoven web from a material; and
calendering the nonwoven web received following the forming step on a calender means, wherein the calender means is a shoe calender.

10. The method of claim 9, further comprising the steps of:
obtaining information pertaining to a number of parameters of the calender means or from the formed nonwoven web from a sensor; and
controlling the calender means with said information.

11. The method of claim 9, wherein said forming step is a carding, airlaid, spun bound, melt blown, spunlaced or wet laid operation.

12. The method of claim 10, further comprising consolidating said nonwoven by drying or thermo bonding.

13. The method of claim 10, wherein said step of obtaining such information is done automatically.

14. The method of claim 10, wherein said parameters include pressure, temperature, or speed of the calender.

15. The method of claim 10, further comprising the step of adjusting said parameters of the calender by way of a process feedback/control loop.
